(19) United States
(12) Patent Application Publication
(10) Pub. No.: US 2008/0089740 A1
(43) Pub. Date: Apr. 17, 2008

(54) FAST-COUPLING DEVICE

(76) Inventor: Sergio Cirio, Canelli (Asti) (IT)

Correspondence Address: PATTERSON & SHERIDAN, L.L.P., 3040 POST OAK BOULEVARD, SUITE 1500, HOUSTON, TX, 77056, US

(21) Appl. No.: 11/697,831

(22) Filed: Apr. 9, 2007

(30) Foreign Application Priority Data
Oct. 17, 2006 (IT) TO2006A000746

(51) Int. Cl. F16B 7/04

(52) U.S. Cl. 403/373

(57) ABSTRACT

Fast-coupling device for mutual connection of two coupleable members, which can be separated from one another and are provided with respective coupling sections. A first of said coupleable members has at least one through opening, which communicates with a front edge of the coupleable member by means of a disengagement groove having a width smaller than the width of said opening. The second coupleable member comprises at least one clamping member, which is mobile in a hole between an extracted position and a retracted position and is pushed elastically towards its extracted position. The clamping member has a surface, which engages the through opening of the first coupleable member. Each clamping member has an actuation portion with a dimension equal to or smaller than the width of said disengagement groove.

### CROSS-REFERENCE TO RELATED APPLICATIONS

This application claims benefit of Italian patent application number TO2006A000746, filed Oct. 17, 2006, which is herein incorporated by reference.

### BACKGROUND OF THE INVENTION

1. Field of the Invention

The present invention relates to a fast-coupling device for coupling two separable components to one another.

2. Description of the Related Art

In many sectors of the art, there is the need to couple separable components, one of which is replaceable, to one another. The invention has been developed in particular in view of its application to capping machines. Usually, capping machines can be configured for operating with containers and with tops of different shapes and dimensions. To make possible operation of the machine with tops and containers of different types, it is necessary to replace some components. For example, in a capping head it is necessary to replace the gripping cone that couples with the top part of the bottles.

### SUMMARY OF THE INVENTION

The purpose of the present invention is to provide a fast-coupling device which will enable coupling and uncoupling of two components to/from one another in a particularly simple and fast way and without the use of tools.

According to the present invention, said purpose is achieved by a fast-coupling device having the characteristics forming the subject of the claims.

### BRIEF DESCRIPTION OF THE DRAWINGS

The present invention will now be described in detail with reference to the attached plate of drawings, which is provided purely by way of non-limiting example and in which:

FIG. 1 is a partially sectioned side view of a head of a capping machine provided with a fast-coupling device according to the present invention;

FIG. 2 is a partially sectioned view at an enlarged scale of the part indicated by the arrow II in FIG. 1;

FIG. 3 is a partially sectioned front view according to the arrow III of FIG. 2;

FIGS. 4 and 5 are partially sectioned views corresponding to FIGS. 2 and 3 and illustrating the members of the fast-coupling device uncoupled from one another;

FIG. 6 is a cross section according to the line VI-VI of FIG. 2;

FIGS. 7 and 8 are sections according to the lines VII-VII and VIII-VIII of FIG. 4;

FIG. 9 is a perspective view of the element indicated by the arrow IX in FIG. 4;

FIG. 10 is a cross section according to the line X-X of FIG. 2; and

FIG. 11 is a cross section illustrating a variant of the part indicated by the arrow XI in FIG. 5.

### DETAILED DESCRIPTION

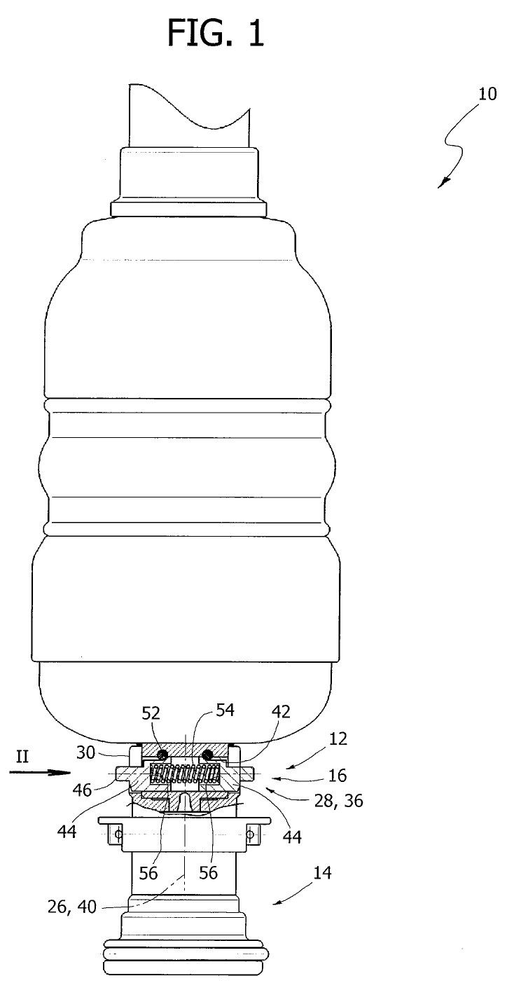

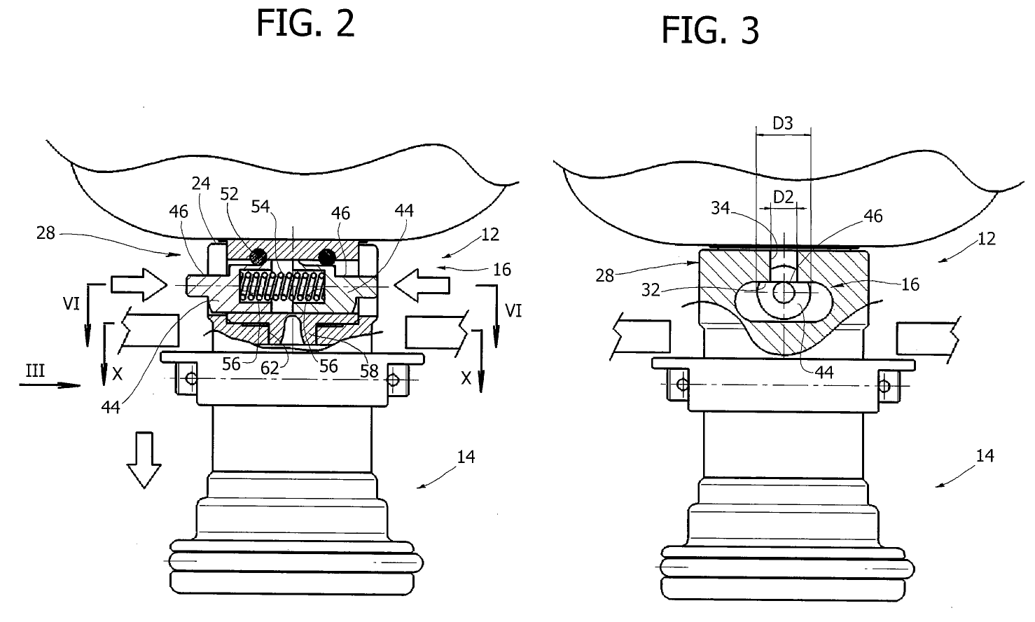

With reference to FIG. 1, the number 10 designates the terminal part of a capping head. The head 10 is provided with a movement of translation in the vertical direction and with a movement of rotation about the same vertical axis. The head 10 comprises a terminal member 12, on which a removable member 14 is mounted, constituted, for example, by a cone for gripping a bottle or similar container. The terminal member 12 and the removable member 14 are connected to one another by means of a fast-coupling device 16.

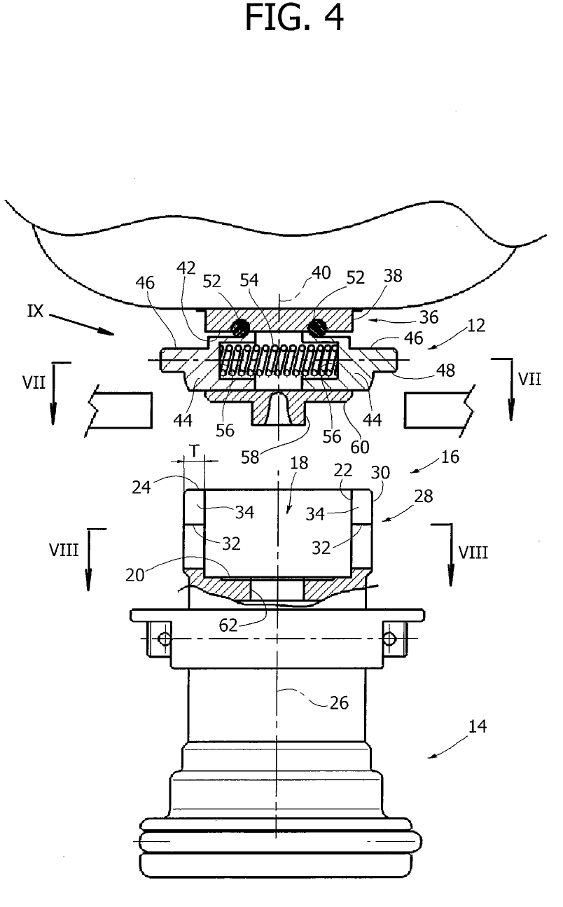

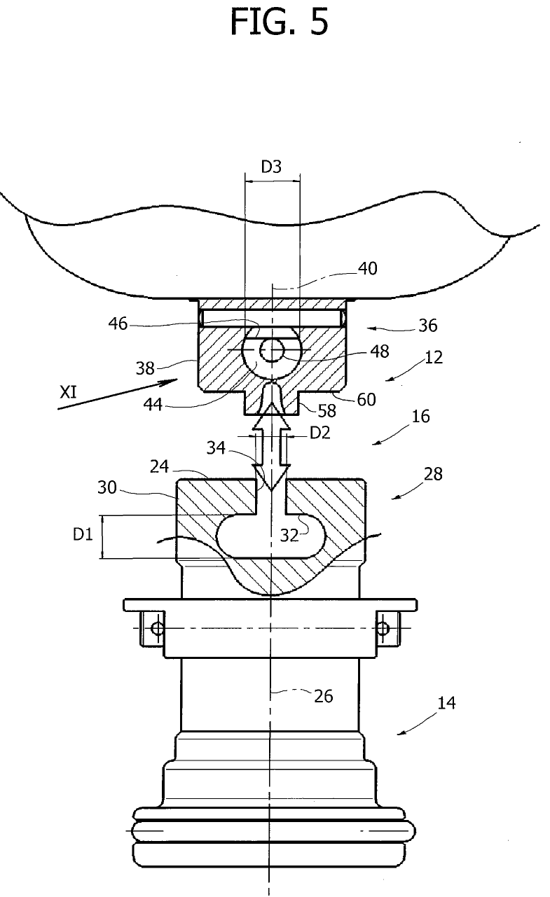

With reference to FIGS. 4 and 5, the removable member 14 has a coupling section 28, in which a coupling seat 18 is formed having an end wall 20 and a side wall 22. The side wall 22 is open on a front edge 24. The removable member 14 has an axis of longitudinal symmetry 26, and the coupling seat 18 is symmetrical with respect to said axis. The coupling seat 18 is surrounded by a wall 30 having a thickness T in the direction orthogonal to the axis 26.

In the wall 30 of the coupling section 28, two slots are made as through slots 32, elongated in the tangential direction. The slots 32 have a height designated by D1 in FIG. 5. Each of the slots 32 communicates with the front edge 24 of the coupling section 28 via a respective through groove 34.

Once again with reference to FIGS. 4 and 5, the terminal member 12 comprises a coupling section 36, designed to couple with the coupling section 28 of the removable member 14. The coupling section 36 has an external surface 38, which establishes a shape fit with the internal surface 22 of the removable member 14. The coupling section 36 is symmetrical with respect to a longitudinal axis 40, which, in the condition of coupling, is aligned to the longitudinal axis 26 of the removable member 14.

The coupling section 36 of the terminal member 12 has a transverse hole 42, orthogonal with respect to the longitudinal axis 40. The hole 42 is a through hole, and its ends give out onto the external surface 38 in positions diametrally opposite to one another.

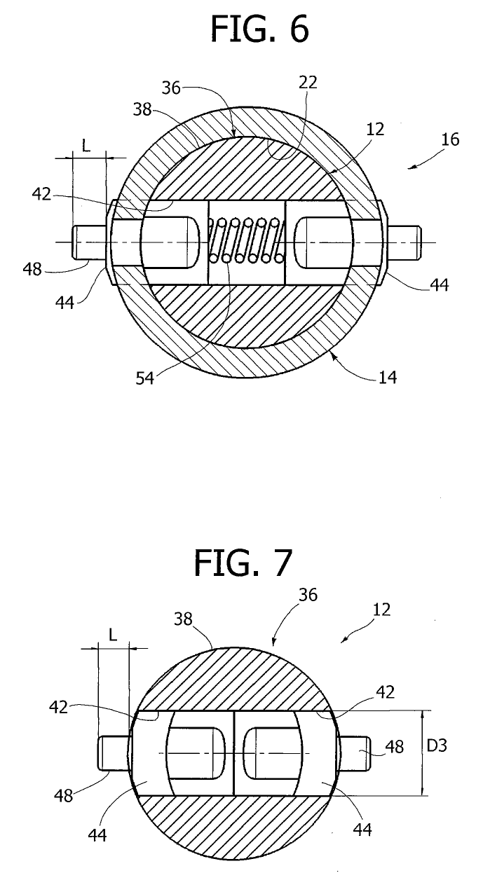

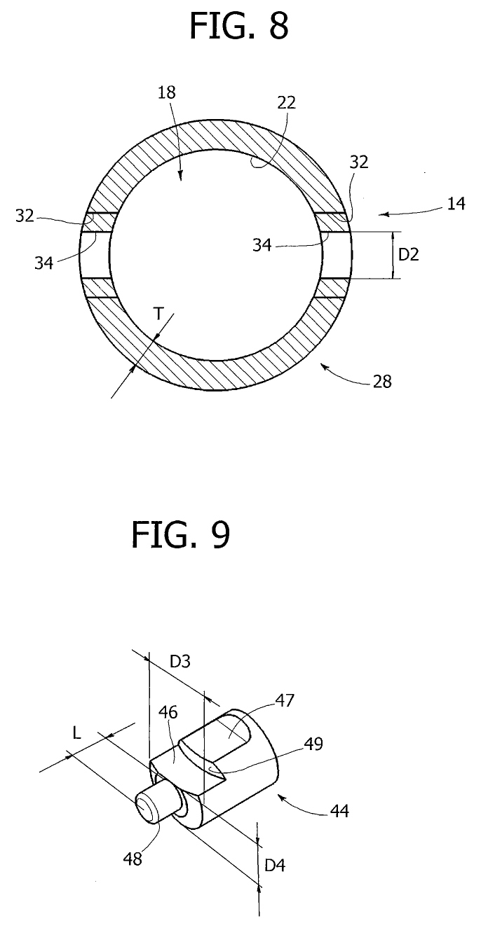

Two clamping members 44 are mounted so that they can slide in the hole 42. With reference to FIGS. 6, 7 and 9, each clamping member 44 has the form of a pin with circular cross section with diameter D3, in which two parallel flattened areas 46, 47 are formed. The width D3 of each clamping member 44 is greater than the width D2 of the respective through groove 34.

The height of the clamping member 44 in a position corresponding to the bottom flattened area 46, designated by D4, is slightly smaller than the height D1 of the groove 32, in such a way that the contact between the clamping member 44 and the removable member 14 is concentrated on the top edge of the slot 32. This is advantageous since, from the technological standpoint, it is more convenient to have an exact fit only between the top edge of the slot 32 and the surface 46 of the clamping member 44. Between the two flattened areas 46, 47 a step is formed having a cylindrical front surface 49 with radius equal to the radius of the internal surface 22 of the seat 18.

Each clamping member 44 has, at its external end, an actuation portion 48, which has a diameter equal to or smaller than the width D2 of the groove 34 of the removable member 14. The length L of the actuation portion 48 is equal to or greater than the thickness T of the wall 32 of the removable member 14. Each clamping member 44 is mobile in the hole 42 between an extracted position and a retracted position.

The radiused terminal part of the top flattened area 47 of each clamping member 44 co-operates with a fixed pin 52 defining a contrast arrest surface, which prevents exit of the clamping member 44 from the hole 42. A helical compression spring 54 pushes the two clamping members 44 towards the outside of the hole 42. The ends of the spring 54 are preferably housed within corresponding blind seats 56 of the clamping members 44.

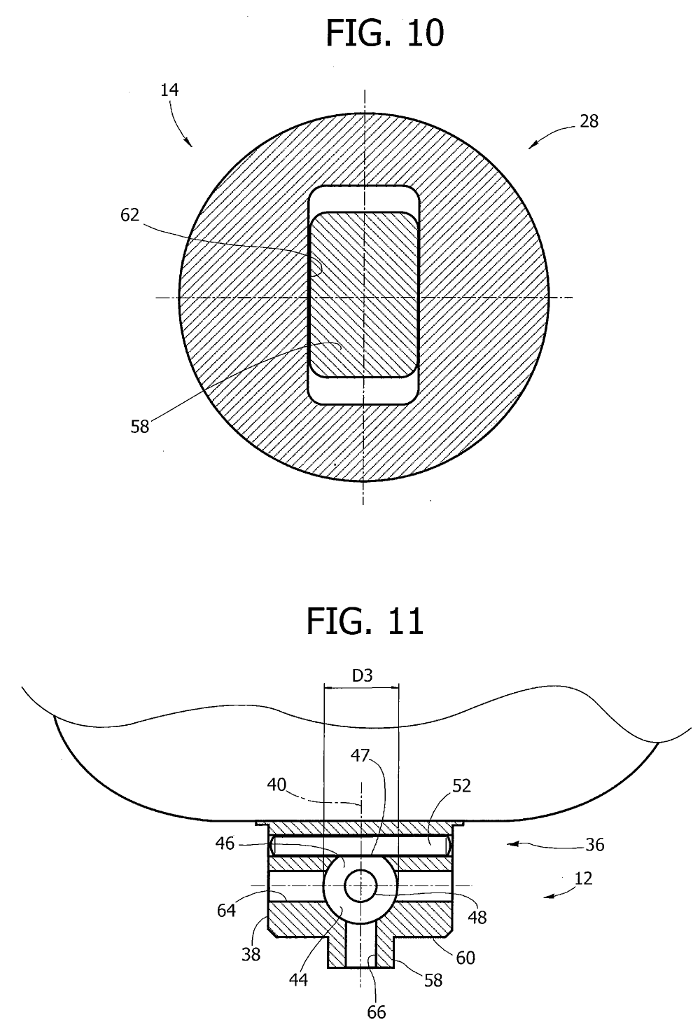

In general, the screwing heads have the purpose of transmitting a torque on a cap, so that, if the head is provided with a fast coupling, it is necessary to have a coupling capable of transmitting torque. For this purpose, with reference to FIGS. 4 and 10, the terminal member 12 is provided with an axial protuberance 58, which projects from a front wall 60. The protuberance 58 has a polygonal profile, for instance rectangular, as illustrated in FIG. 10. The protuberance 58 engages a cavity 62 with a corresponding shape provided in the coupling section 28 of the removable member 14.

The operation of the fast-coupling device according to the invention will now be described starting from the configuration in which the removable member 14 is separated from the terminal member 12 (FIGS. 4 and 5).

To connect the removable member 14 to the terminal member 12, a pressure is exerted on the actuation portions 48 of the two clamping members 44 set opposite to one another, by simultaneously pushing the two clamping members 44 towards the inside of the hole 42. By keeping the clamping members 44 pressed inwards, the removable member 14 approaches the terminal member 12 in the direction of the longitudinal axes 26, 40. The surface 38 of the terminal member 12 inserts in the seat 18 of the removable member 14. During this insertion, the grooves 34 are aligned to the actuation portions 48 of the clamping members 44.

Once insertion is completed, the clamping members 44 are released and, under the action of the spring 54, are brought back into their extracted position. In this position, the flattened areas 46 of the clamping members 44 engage the internal top edges of the respective slots 32. At this point assembly is completed.

To remove the removable member 14, the procedure is reversed; i.e., the clamping members 44 are pushed inwards, and the seat 18 disengages from the surface 38 with a movement in the axial direction of the removable member 14.

The clamping members 44 connect the removable member 14 to the terminal member 12 in the vertical direction, whilst the rotational coupling for transmission of torque is obtained thanks to the engagement between the protuberance 58 and the seat 62. The constraint in the vertical direction obtained by means of the clamping members 44 is intrinsically secure since, even in the case of loss of the pins 56 during operation, the surface 49 of each clamping member 44 rests against the surface 18, preventing the clamping member 44 from sliding out. It would of course be possible to reunite the rotational coupling and the axial coupling by replacing the slots 32 with holes with circular cross section, which establish a shape fit with the external surfaces of the clamping members. This involves, however, greater technological difficulties.

The details of construction and the embodiments of the fast-coupling device according to the present invention may vary with respect to what is illustrated in the figures. The surfaces of mutual coupling 22, 38 can be cylindrical or else have the shape of a truncated cone. Said surfaces of coupling can have a circular or else a polygonal cross section.

The slots 32 could be replaced by openings of any shape, for instance circular.

In the case where the removable member 14 is to be mounted on the terminal member 12 with a pre-set orientation, the two slots 32 of the removable member 14 can be envisaged with shape or dimensions different from one another. In this case, the clamping members 44 will have shape and dimensions complementary to those of the respective slots 32.

Illustrated in the figures is the case where the fast-coupling device comprises two clamping members 44 arranged in positions diametrally opposite to one another. The number of the clamping members may vary according to the requirements. For instance, there could be provided just one clamping member 44, or else three or more clamping members could be provided. Each clamping member could be associated to a respective spring, or else a single elastic element could be provided co-operating with all the clamping members.

With reference to FIG. 11, in a variant of the present invention the coupling section 36 of the terminal member 12 is provided with two holes 64, 66 with mutually orthogonal axes. The first hole 64 is a through hole and extends in a transverse direction with respect to the hole 42 in which the clamping members are mounted. The second hole 66 extends in an axial direction and communicates at the top with the first hole 64 and at the bottom with the outside. Said holes enable washing of the internal parts of the terminal member 12. In fact, the holes 64 and 66 enable entry and subsequent draining-off of the washing liquid.

While the foregoing is directed to embodiments of the present invention, other and further embodiments of the invention may be devised without departing from the basic scope thereof, and the scope thereof is determined by the claims that follow.

1. A fast-coupling device for mutual connection of two coupleable members, which can be separated from one another and are provided with respective coupling sections,
said device being characterized in that a first of said coupleable members has at least one through transverse opening, which communicates with a front edge of the coupleable member by means of a disengagement groove having a width smaller than the width of said opening, and in that the second coupleable member comprises at least one clamping member, which is mobile in a hole between an extracted position and a retracted position and is pushed elastically towards its extracted position, said clamping member having a surface, which engages said opening of the first coupleable member, each clamping member having an actuation portion with a dimension equal to or smaller than the width of said disengagement groove.

2. The device according to claim 1, wherein said coupling sections are provided with respective formations in mutual contact of transmission of torque.

3. The device according to claim 1, wherein said clamping member provides an axial connection of said coupleable members.

4. The device according to claim 1, wherein the actuation portion of said clamping member has a length equal to or greater than the thickness of said opening.

5. The device according to claim 1, wherein the mutual-coupling sections of the two coupleable members co-operate with one another to establish a shape fit.

6. The device according to claim 1, wherein the coupling section of the first coupleable member has a seat with a side wall in which said through opening is made.

7. The device according to claim 1, wherein it comprises at least two clamping members diametrally opposite to one another and pushed towards the outside of the cross section of coupling by elastic compression means.

8. The device according to claim 1, wherein the coupling section of one of said coupleable members is provided with holes for entry and exit of washing liquid.

9. The device according to claim 1, wherein the clamping member comprises a cylindrical front surface, which prevents exit of the clamping member from the respective hole when the coupleable members are connected to one another.
